(19) United States
(12) Patent Application Publication
(10) Pub. No.: US 2006/0070752 A1
(43) Pub. Date: Apr. 6, 2006

(54) Rotary cultivator

(76) Inventors: Colin Amor, Beaucastle (GB); John Allen, West Midlands (GB)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/538,085

(22) PCT Filed: Dec. 16, 2003
(86) PCT No.: PCT/GB03/05469

§ 371 Date: Jun. 8, 2005

(30) Foreign Application Priority Data
Dec. 18, 2002 (GB) 0229562.4

(51) Int. Cl. A01B 33/00

(52) U.S. Cl. 172/41

(57) ABSTRACT

A rotary cultivator (10) has an elongate tubular handle member (12), a cultivator tool (14) rotatably mounted at one end of the handle member (12) and an electric motor drive unit (16) mounted at the other end of the handle member (12), the handle member (12) being curved adjacent the end to which the cultivator tool (14) is mounted, a flexible drive element (22) extending within the tubular handle member (12), the flexible drive element (22) being connected directly at one end to the electric motor drive unit (16) and at the other end to the cultivator tool (14).

The present invention relates to rotary cultivators and in particular to rotary cultivators powered by electric motor means.

Rotary cultivators have been proposed in the past in which a ground engaging cultivator tool is driven by an electric motor about the rotational axis of the motor. Generally in such cultivators, the electric motor is positioned close to the cultivator tool. In this manner, the electric motor is exposed to dirt and dust thrown up by the cultivator tool. Moreover, in wet conditions, there is a serious risk of the motor being shorted out due to the accumulation of moisture. p Where the motor is located remote from the cultivator tool, an angle drive is required to connect the drive shaft from the motor to the cultivator tool, further complicating the design.

A further problem with such cultivators is that they are subjected to significant torsional shocks when, for example, the cultivator tool encounters a rock or hard ground. The shocks produced in such circumstances may damage the electric motor or angled drive and may also injure the operator.

In accordance with the present invention, a rotary cultivator comprises an elongate tubular handle member, a cultivator tool rotatably mounted at one end of the handle member and an electric motor mounted at the other end of the handle member, the handle member being curved adjacent the end to which the cultivator tool is mounted, a flexible drive element extending within the tubular handle member, the flexible drive element being connected directly at one end to the electric motor and at the other end to the cultivator tool.

With the rotary cultivator according to the present invention, the electric motor is remote from the cultivator tool so that the problems with regard to dirt, dust and moisture are avoided. Moreover, the flexible drive between the cultivator tool and the electric motor, will avoid the need for angle drives and will absorb torsional shocks, thereby protecting the motor against damage and the user against injury.

According to the preferred embodiment of the invention, the electric motor is provided by a dedicated drive unit, the housing of which is secured to the upper end of the tubular handle member. According to another embodiment of the invention, a portable drill or like appliance, may be used as the drive unit, releasable attachment means being provided at the upper end of the tubular handle member for engagement of the portable drill or like appliance.

The electric motor may be powered from the mains or by means of batteries. According to a further preferred embodiment, the drive unit may have a torque limiting clutch arrangement to further protect the electric motor from torsional shocks.

The handle member may be formed as a single piece but may alternatively be formed from several sections, which may be interconnected in suitable manner, so that the handle may be disassembled for transport and storage purposes.

The cultivator tool preferably has a hub of circular configuration having a plurality of axially extending tine formations, for engagement of the ground. Alternative attachments may be connected in place of the cultivator tool, for example, a brush or lawn edge cutting tool.

The invention is now described, by way of example only, with reference to the accompanying drawings, in which:

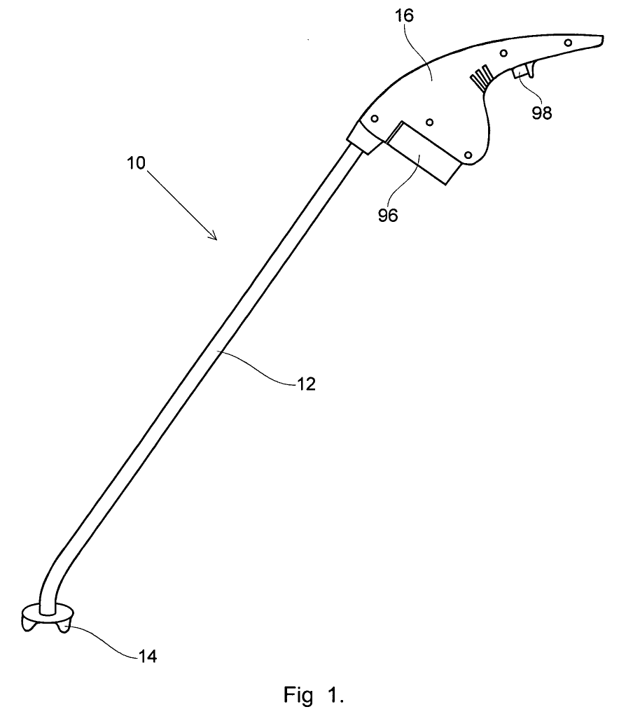

FIG. 1 shows a perspective view of a rotary cultivator in accordance with the present invention;

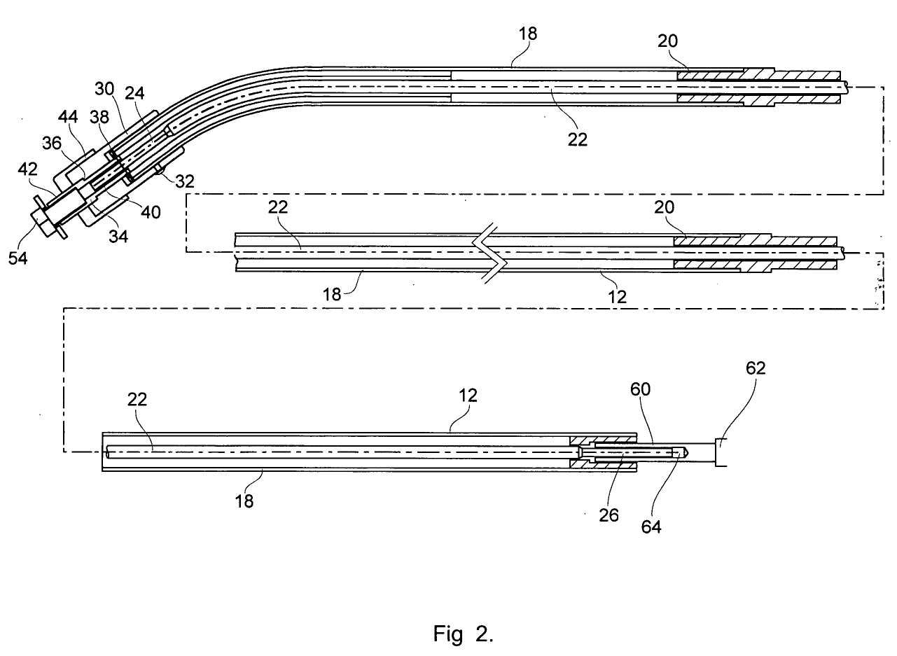

FIG. 2 shows a part sectional view of the handle/drive of the rotary cultivator illustrated in FIG. 1;

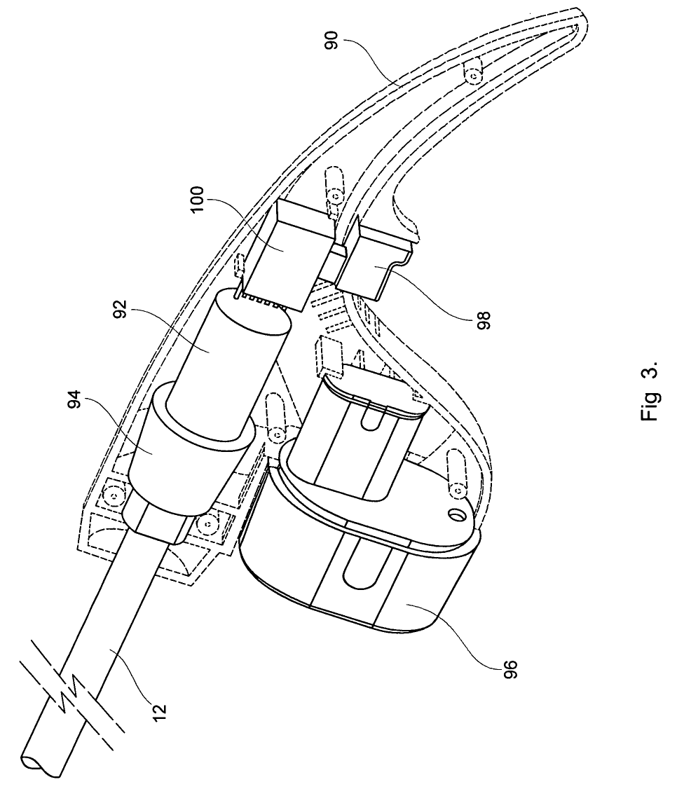

FIG. 3 shows a sectional perspective view of the motor unit of the rotary cultivator illustrated in FIG. 1;

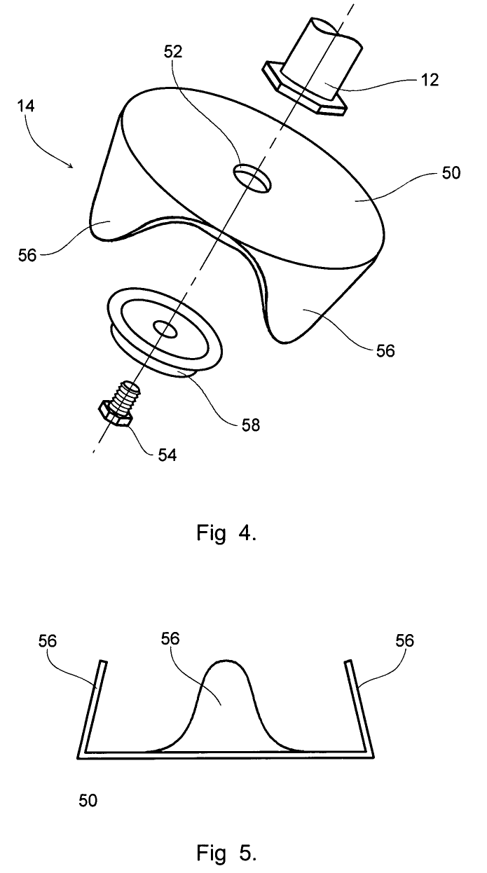

FIG. 4 shows an explodes perspective view of a cultivator tool assembly of the rotary cultivator illustrated in FIG. 1;

FIG. 5 shows a sectional side elevation of the cultivator tool illustrated in FIG. 4;

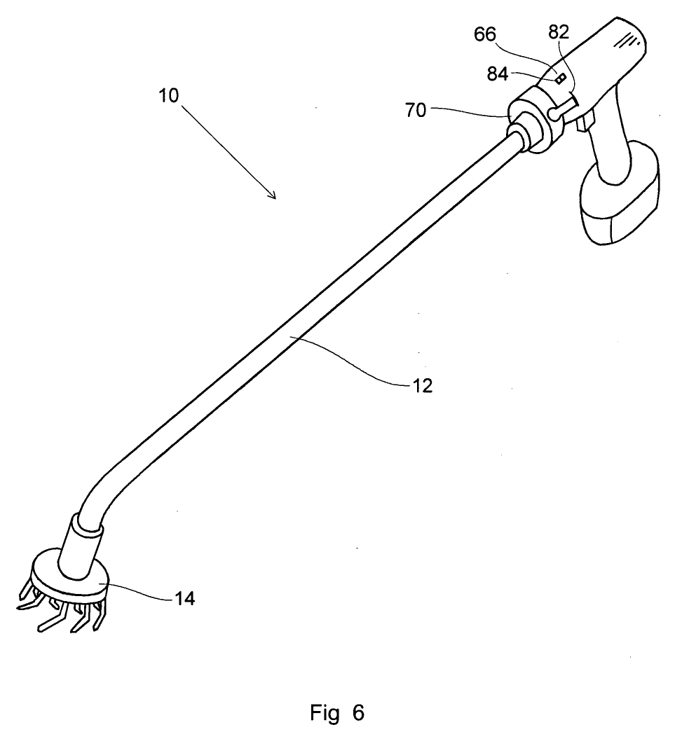

FIG. 6 shows an alternative embodiment of the invention;

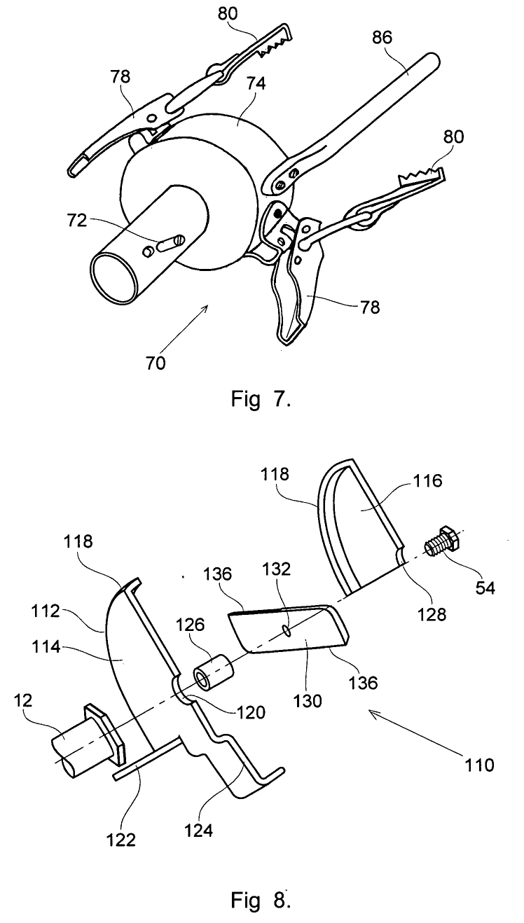

FIG. 7 shows a perspective view of a motor attachment means of the rotary cultivator illustrated in FIG. 6; and

FIG. 8 shows an exploded perspective view of a lawn edge cutting attachment for use with the rotary cultivator illustrated in FIG. 1.

As illustrated in FIG. 1, a rotary cultivator 10 comprises a tubular handle member 12 with a cultivator tool 14 rotatably mounted to the lower end of the handle member 12 and a cordless electric motor drive unit 16 mounted to the upper end of the handle member 12.

As illustrated in greater detail in FIG. 2, the tubular handle member 12 is formed from three sections 18, the sections 18 being interconnected by plastic sleeve members 20 which locate inside the ends of the tubular sections 18. A flexible drive element 22 is located within the handle member 12 and extends from one end of the handle member 12 to the other. The plastic sleeve members 20 act as guides and bearings for the flexible drive element 22. The flexible drive element 22 is of conventional design and may, for example, comprise one or more wires which are wound helically to provide a unidirectional drive element, the drive element 22 being rotated in a direction which will tighten the helical turns. Drive formations 24,26 of non-circular section, for example square section, are provided at each end of the flexible drive element 22.

A bush unit 30 is secured to the lower end of the tubular handle member 12 and is secured thereto in suitable manner, for example by means of one or more set screws 32. An arbor 34 is rotatably mounted in the bush member 30 and is secured axially thereof by means of a shoulder portion 36 and a star washer or circlip 38. The inner end of the arbor 34 has a socket formation 40 which is drivingly engaged by the drive formation 24 of the flexible drive element 22. A screw threaded bore 42 is provided at the outer end of arbor 34, by which the cultivator tool 14 may be bolted to the arbor 34.

A rubber end cap 44 engages over the outer end of arbor 34 and the end of bush unit 30, to provide a seal preventing ingress of dirt and moisture into the bush unit 30 and to retain lubricant in the bush unit 30.

As illustrated in FIG. 4, the cultivator tool 14 comprises a flange formation 50 with a central aperture 52, through which a bolt 54 may pass, to secure the cultivator tool 14 to the arbor 34. A thrust washer 58 is provided between the head of blot 54 and flange formation 50. The aperture 52 and bolt 54 may be shaped, for example with a flat, to prevent relative rotation of the cultivator tool 14 with respect to the arbor 34. Alternatively, locking tabs may be provided on the flange formation 50 for engagement of flats on the head of the bolt 54 or for engagement of flats on the arbor 34, to prevent relative rotation.

A series of angularly spaced axially extending tine formations 56 extend from the outer periphery of the flange formation 50, the tine formations 56 being angled inwardly away from the flange formation 50.

According to a further modification, the tines formations 56 may be twisted in the plane of the flange formation 50 from the leading edge to the trailing edge, in order to improve the amount of soil disturbance.

According to a further modification, the tines of the cultivator tool 14 may be formed independently of the flange formation 50, for example from round bar, and secured to the flange formation 50 in suitable manner. By this means, the shape of the tines may be of any desired configuration.

As illustrated in FIG. 3, electric motor drive unit 16 has a plastic case 90 (shown in broken line) which houses an electric motor 92 and reduction gearbox unit 94. A rechargeable battery pack 96 may be plugged into the housing 90, to provide power to the unit. Power to the electric motor 92 is controlled by trigger 98 and variable speed control 100. An arbor 60 with a socket formation 64 is mounted on the output shaft 62 from the gearbox unit 94 (see FIG. 2), for engagement of the drive formation 26 at the upper end of the flexible drive 22.

In the alternative embodiment illustrated in FIG. 6, the drive unit 16 is in the form of a cordless portable electric drill 66, the drill 66 is releaseably attached to the upper end of handle member 12 by an attachment assembly 70.

As illustrated in FIG. 7 the drill attachment assembly 70 is secured to the upper end of tubular handle member 12 in suitable manner, for example by means of one or more set screws 72. The drill attachment assembly 70 has a cylindrical housing 74 for engagement of the nose of the drill 66. Formations may be provided on the internal diameter of the housing 74 for engagement of corresponding formations on the nose of drill 66, to locate the drill 66 axially and/or rotationally with respect to the housing 74.

A pair of toggle latches 78 are provided on the housing 74, the toggle latches 78 having detent formations 80 for engagement of corresponding formations, for example slots 82, on the drill 66, so that the toggle latches 78 may be used to clamp the drill 66 to the housing 74.

If the drill 66 has a direction reversing switch 84, a guard 86 may be provided on the housing 74, to prevent actuation of the switch 84 to reverse the direction of rotation from that in which the flexible drive element 22 will operate.

In place of the cultivator tool 14, other attachments may be attached to the lower end of the flexible drive 22. For example a brush attachment may be attached to the rotary cultivator 10, which may be used, for example, for the removal of weeds or moss from between paving stones.

Alternatively a lawn edge cutting attachment 110 as shown in FIG. 8 may be attached to the rotary cultivator 10. The lawn edge cutting attachment 110 comprises a guard member 112 having inner and outer side walls 114,116 interconnected by a cylindrical wall 118 which extends around the periphery of walls 114,116 for about 180°. The inner wall 114 has a circular aperture 120 which is greater than the diameter of bolt 54. The outer portions of the of the inner wall 114, below the aperture 120, are bent at 90° to the plane of the wall 114, to provide a pair of guides 122, while the inner portion extends downwards to provide a grass guide 124.

The outer wall 116 is semicircular having a semicircular recess 128 to provide a clearance for the head of bolt 54.

A rotating cutting blade 130 has a central threaded bush 132, which corresponds to the thread of bolt 54. The rotating cutting blade 130 is provided with a pair of hardened cutting edges 136 on diametrically opposed leading edges. A tubular spacer 126 is provided between the cutting plate 130 and the the arbor 34 at the lower end of the flexible drive 22, to space the cutting blade 130 from the grass guide 124.

When assembled, the bolt 54 is screwed into the rotating cutting plate 130, the bolt 54 and spacer 126 pass through the aperture 120 of the guard 112 and is secured to end of flexible drive 22, to clamp the assembly to the lower end of handle assembly 12. Inter-engaging formations (not shown) are provided to locate the guard 112 with respect to the lower end of the handle assembly 12.

In use, as the guides 122 are run along the surface of the lawn and the grass guide 124 will deflect grass growing along the edge of the lawn towards the cutting blade 130.

Various modifications may be made without departing from the invention. For example where a portable electric drill is used, the method of attachment of the drill may also be varied, for example the method of attachment may be adapted to utilise features incorporated into the drill design by the drill manufacturer, for attachment of the drill to other tools. Moreover, instead of the toggle latches 78, the drill 66 may be clamped to the housing 74 in other ways, for example by means of a strap which extends all the way round the body of the drill 66.

A grip may be attached to the handle member 12, intermediate of the drive unit 16 and the cultivator tool 14, to facilitate manipulation of the cultivator.

1-15. (canceled)

16. A rotary cultivator (10) comprising an elongate tubular handle member (12), a cultivator tool (14) rotatably mounted atone end of the handle member (12) and an electric motor drive unit (16) mounted at the other end of the handle member (12), the handle member (12) being curved adjacent the end to which the cultivator tool (14) is mounted, a flexible drive element (22) extending within the tubular handle member (12), the flexible drive element (22) being connected directly at one end to the electric motor drive unit (16) and at the other end to the cultivator tool (14).

17. The rotary cultivator (10) according to claim 16, wherein the electric motor drive unit (16) is provided in the form of a dedicated drive unit secured to the upper end of the handle member (12).

18. The rotary cultivator (10) according to claim 16, wherein the electric motor drive unit (16) is provided in the form of a portable drill (66) or like appliance.

19. The rotary cultivator (10) according to claim 18, wherein that attachment means (70) is provided at the upper end of the handle member (12) for securing a drill (66) or like appliance to the handle member (12).

20. The rotary cultivator (10) according to claim 19, wherein means (78,80) is provided for clamping the drill (66) or like appliance to the attachment means (70).

21. The rotary cultivator (10) according to claim 16, wherein the drill (60) or like appliance is connected to the flexible drive (22) by means of a drive member (60), and the drive member (60) has a socket formation (64) for engagement of a drive formation (26) on the flexible drive (22).

22. The rotary cultivator (10) according to claim 16, wherein the electric motor drive unit (16) is powered by batteries (96).

23. The rotary cultivator (10) according to claim 16, wherein the electric motor drive unit (16) is powered from a mains supply.

24. The rotary cultivator (10) according to claim 16, wherein the electric motor drive unit (16) is connected to the flexible drive (22) by a torque limiting clutch.

25. The rotary cultivator (10) according to claim 16, wherein the cultivator tool (14) comprises a flange formation (50) with a plurality of tine formations (56) extending in a direction of the axis of rotation of the flange formation (50).

26. The rotary cultivator (10) according to claim 25, wherein cylindrical tine formations (56) extend axially from the outer periphery of the flange formation (50), at angularly spaced locations.

27. The rotary cultivator (10) according to claim 25, wherein the tine formations (56) are angled inwardly away from the flange formation (50).

28. The rotary cultivator (10) according to claim 16, wherein the cultivator tool (14) is connected to the flexible drive (22) by an arbor (34), the arbor (34) has a socket formation (40) for engagement of a drive formation (24) on the flexible drive (22) and being rotatably mounted in a bush unit (30) secured to the lower end of the handle member (12).

29. The rotary cultivator (12) according to claim 16, wherein the handle member (12) is formed from a plurality of sections (18), the plurality of sections (18) are releasably interconnected by sleeve members (20) which engage the ends of adjacent sections (18).

30. The rotary cultivator according to claim 29, wherein the sleeve members (20) act as guides and bearings for the flexible drive element (22).
